(19) United States
(12) Patent Application Publication
(10) Pub. No.: US 2025/0069040 A1
(43) Pub. Date: Feb. 27, 2025

(54) Video Sharing Job Application

(71) Applicant: Vahe Parsadanyan, Myrtle Beach, SC (US)

(72) Inventor: Vahe Parsadanyan, Myrtle Beach, SC (US)

(21) Appl. No.: 18/811,875

(22) Filed: Aug. 22, 2024

Related U.S. Application Data
(60) Provisional application No. 63/533,984, filed on Aug. 22, 2023.

(51) Int. Cl. G06Q 10/1053; G06F 16/735

(52) U.S. Cl. CPC G06Q 10/1053; G06F 16/735

(57) ABSTRACT

The present application is directed to a computer-based application for identifying a new video associated with a user account of a content sharing application, identifying one or more previously identified videos linked to one or more information tags matching one or more information tags linked to the new video, queuing the new video to be displayed in a video feed of one or more other user accounts of the content sharing application, and queueing the one or more previously identified videos to be displayed in a video feed of the user account.

### I. RELATED APPLICATIONS

The present application claims priority to U.S. Provisional Patent Application No. 63/533,984, filed on Aug. 22, 2023, the disclosure of which is hereby incorporated by reference in its entirety.

### II. FIELD OF INVENTION

The present application relates to a computer application that operates to share both job offerings and job requests via video information and to pair those types of postings among interested parties.

### III. BACKGROUND OF THE INVENTION

Conventionally, online applications which share information, such as FACEBOOK, INSTAGRAM, SNAPCHAT, TIKTOK, etc., permit, text, images and/or video to be shared. The growing interest in video content provides more information faster about a particular person, place or thing.

Job sites which promote the sharing of resumes and job postings have limits on the visibility of certain job applicant candidates and respective job employer candidates. All the information shared is written and the specific examples of types of tasks that need to be completed by employers, and the skills of a candidate remain as words on paper with little to no chance of being shared with the ideal candidates for employment opportunities.

### IV. SUMMARY OF THE INVENTION

Example embodiments of the present application disclose hardware, software and/or operations and procedures configured to matching identifiers of videos shared by various user accounts subscribed to a social networking platform and distributing videos to the various user accounts by exchanging one or more videos between the user accounts.

One example process may include identifying a new video associated with a user account of a content sharing application, identifying one or more previously identified videos linked to one or more information tags matching one or more information tags linked to the new video, queuing the new video to be displayed in a video feed of one or more other user accounts of the content sharing application, and queueing the one or more previously identified videos to be displayed in a video feed of the user account.

### V. BRIEF DESCRIPTION OF THE DRAWING(S)

FIG. 1 illustrates an example network configuration of client devices participating in a job sharing social networking application, in accordance with example embodiments.

FIG. 2 illustrates example network configuration of client devices participating in a job sharing social networking application where an association is made based on content of the job posting, in accordance with example embodiments.

FIG. 3 illustrates an example graphical user interface (GUI) of an automated exchange of job and service video postings, in accordance with example embodiments.

FIG. 4A illustrates another example graphical user interface (GUI) of a user device operating the job sharing social networking application, in accordance with example embodiments.

FIG. 4B illustrates another example graphical user interface (GUI) of a user device operating the job sharing social networking application to setup a new job posting, in accordance with example embodiments.

FIG. 4C illustrates another example graphical user interface (GUI) of a user device using the job social networking application to view a history of videos in a user profile, in accordance with example embodiments.

FIG. 4D illustrates another example graphical user interface (GUI) of a user device using the job sharing social networking application to establish job parameters in a user profile, in accordance with example embodiments.

FIG. 4E illustrates another example graphical user interface (GUI) of a user device displaying a map of candidates for jobs and services in the job social networking application, in accordance with example embodiments.

FIG. 5A illustrates an example video shared by a job master on their profile according to example embodiments.

FIG. 5B illustrates an example profile page of a job master according to example embodiments.

FIG. 5C illustrates another example of the profile page of a job master according to example embodiments.

FIG. 5D illustrates an example map identifying locations associated with master profiles according to example embodiments.

FIG. 5E illustrates an example map identifying locations associated with master profiles with a specific master selected according to example embodiments.

FIG. 5F illustrates an example map identifying locations associated with master profiles and job profiles according to example embodiments.

FIG. 5G illustrates an example user interface of a list of job videos associated with a particular location according to example embodiments.

FIG. 5H illustrates an example user interface summarizing transactions performed by the job sharing application according to example embodiments.

FIG. 5I illustrates an example list of skills which can be selected to associate with a particular user profile according to example embodiments.

FIG. 6 illustrates an example user profile data queueing process according to example embodiments.

FIG. 7 illustrates an example process of sharing content among users of the job sharing application according to example embodiments.

FIG. 8 illustrates an example network entity device configured to store instructions, software, and corresponding hardware for executing the same, according to example embodiments of the present application.

### VI. DETAILED DESCRIPTION OF THE EMBODIMENT(S)

It will be readily understood that the components of the present application, as generally described and illustrated in the figures herein, may be arranged and designed in a wide variety of different configurations. Thus, the following detailed description of the embodiments of a method, apparatus, computer application and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

According to example embodiments, a phone application downloadable, purchasable, etc., may be received by a user of an electronic user computer device (e.g., a smartphone, mobile device or personal computer). Additionally, any references to a computer or electronics device may be directed to a computer, laptop, mobile, wireless or cellular phone, a PDA, a tablet, a client a server or any device that contains a processor and/or memory, whether that processor or memory performs a function related to an embodiment of the application.

According to example embodiments, the software application is configured to provide a user(s) of a mobile device or tablet or other computer device with a job opportunity and/or customer opportunities for job requests they have posted by video. In operation, a user may post one or more videos to demonstrate their services, such as a skilled trade, including, for example, dog walking, power washing, painting, carpentry, car detailing, landscaping, plumbing, auto mechanics, will and estate legal document preparation, funeral services, clothing tailoring, etc. In one example, a carpenter may create a video of themselves building a door frame or installing a window. That video created under that particular user profile on the application installed on the user device may enable potential customers to contact them and watch their skill video, and the video or videos may appear on the potential customers video feed once that potential customer has posted a video of a service needed for something that is related to the content of the video posted by the carpenter.

A video that is made requesting a potential skilled tradesman or other professional may be referred to a ‘job video’ that is posted by a job requesting user via their respective computing device and user account profile. That user or person needing that type of service may create a job video demonstrating the details needed. In one example, a requesting user may post a video panning a view of their yard and explaining what they would like to have done to fix up their yard in a landscaping capacity. The video may include a yard, leaves that need to be collected, weeds that need removal, trees that need pruning, flower beds that need replanting, areas that need mulching, areas that need grass cutting, edging, etc.

Continuing with the same example for landscaping services, a master service account may be registered with the same software application platform to post professional videos about services which are offered by that particular ‘service master’. The service master may be setup as a registered profile of someone seeking work, gigs, etc., which pay money in exchange for the services, and which can lead to one-time or ongoing work deals between the requesting user account and the master service account. The videos on two individual user accounts may be exchanged automatically by categorization of the videos resulting from a video post by each user. For example, as a requesting user is attempting to share a video of their lawn, yard, etc., the video may be limited to a short period of time, such as 15 seconds and may include whatever the requesting user is willing to share, such as a messy yard in need of service. The video created by the requesting user is saved to the requesting user profile and may be tagged as yard work, landscaping, etc., or other terms and phrases which best describe the content of the video based on pre-registered tags, an audio analysis of the video audio, and/or a video analysis of the video images, etc.

Artificial intelligence may autonomously tag the video with terms and phrases related to certain jobs. One example of AI may include still frames from the video being analyzed by an image content analyzation application that identifies objects, such as bushes, grass, leaves, trees, etc. The data repository may include a number of job description tags which can be applied depending on the type of content in the image and/or audio of the video. Once the content is identified from one or more still frames of the video, the objects identified from the content can be paired with tags describing similar subject matter. One example may include a tree being identified, then the tree can be paired with landscaping, tree services, yard work, etc., depending on the relevant tags in the data repository of job descriptions. Similarly, the audio may be converted from speech to text and then parsed to identify the verbs and nouns and other relevant phrases which correlate with the job descriptions list stored in the data repository.

The job descriptions can then be selected by the correlation between the image and/or audio of the video data and the terms used by the application. A comparing algorithm may be applied to pair terms and content objects with the limited list of relevant job descriptions. The job descriptions applied to each video may be compared to job descriptions of registered masters in a particular geographical area, such as 10, 20, 50, miles, etc., depending on the radius selected by each master profile and a location of the requesting user's profile. A video associated with a requester profile may be sent to a message feed or other information alert portion of the master profile once the job descriptions match both profiles and other criteria of the master profile are satisfied, such as a distance radius limiting an area where the master profile would like to perform work.

When a user submits a job video, that particular job video will have whatever content the user is comfortable sharing to explain the details of a task that needs to be completed with the idea that the best candidates will have their master skill videos be made available on the job posting user's feed for content which is related or similar to the original job posting associated with the job video. In one example, the user posting the job video may be posting a video about needing some gardening and landscaping needs and may post a job as a 30 second video that describes how the backyard needs to have edges installed around the grass to prevent weeds from migrating from the edge of the yard to the grass portion. Once the video is posted and tagged as ‘landscaping’, ‘yard work’, etc., any master accounts created which have videos and correlating tags and/or identifiers may have their videos automatically imported to the user's feed provided the users are located in a same general area defined by the master account. Also, the video posted by the user job seeker may have that video sent to those master accounts and queued for a next viewing on the user interface of the application.

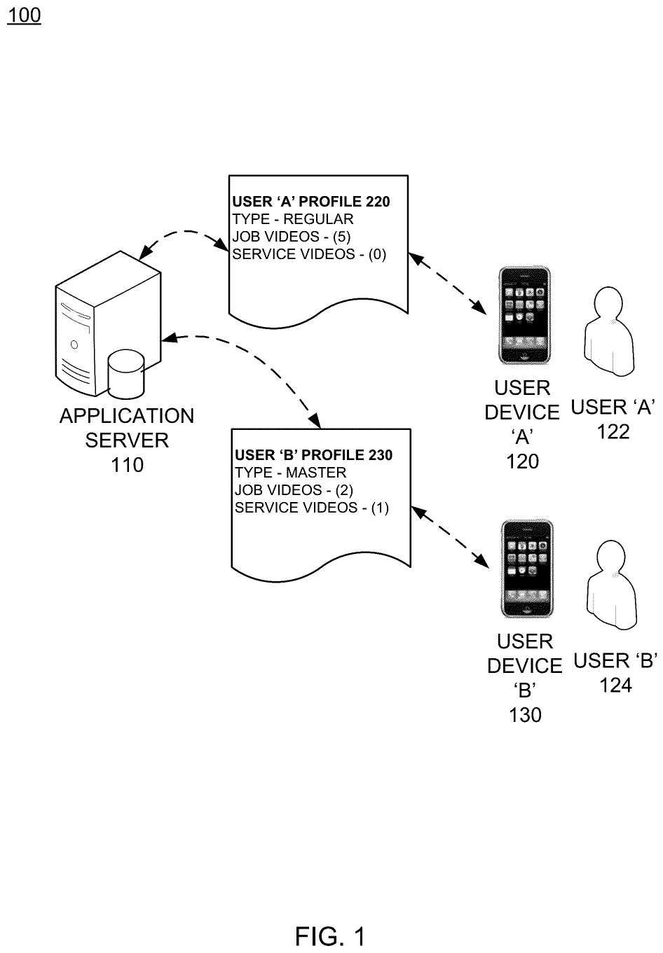

FIG. 1 illustrates an example network configuration of client devices participating in a job social networking application, in accordance with example embodiments. Referring to FIG. 1, the network configuration 100 may include one or more end users registered via user profiles to access an application for job sharing. An application server 110 may be a cloud based server, a local server, a computer or any computing device that is responsible for maintaining a record of registered user accounts and for associating the user submitted videos with other relevant user profiles so the content can be shared properly to maximize the likelihood that users will identify one another for relevant categories of work.

The user ‘A’ 122 may be operating a user device ‘A’ 120 that is operating the job sharing application. The application may be setup with a user profile that includes information associated with the user ‘A’. The user profile 220 may include a number of job videos, such as five (5) videos that user ‘A’ has posted for various potential professionals to view who are valid candidates based on the content associated with the video files and any parameters established by user ‘A’, such as location, etc. Another user ‘B’ 124 may be using a device 130 to share videos as a master account setup to share a professional profile of the user as a master professional of one or more skills. In one example, the user ‘B’ profile 230 may be for a landscaper that has posted two job videos to recruit employees and one professional video to demonstrate the skills that user ‘B’ offers to others for a hired job.

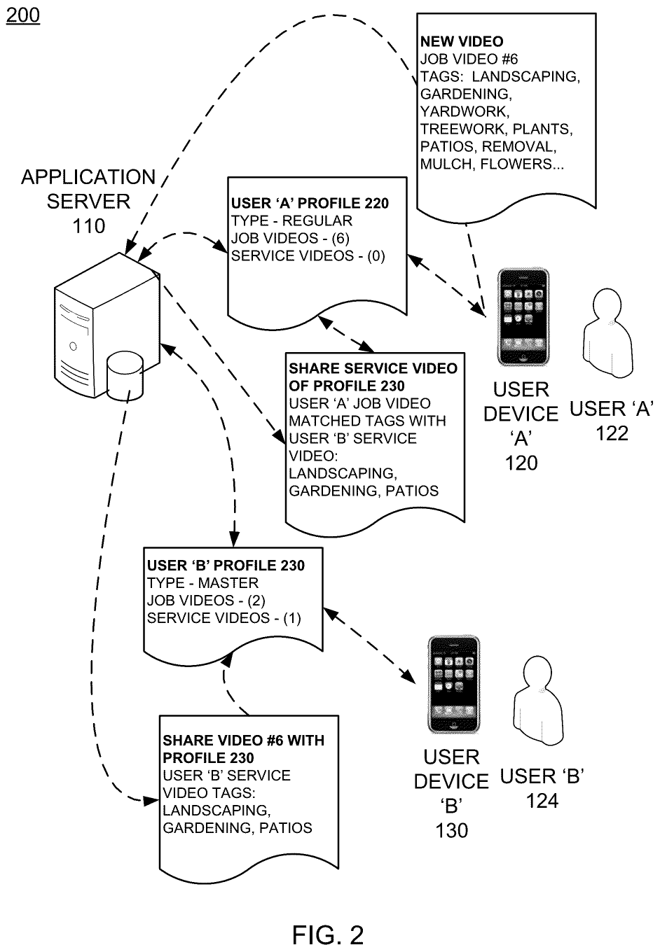

FIG. 2 illustrates example network configuration of client devices participating in a job social networking application where an association is made based on content of the job posting, in accordance with example embodiments. Referring to FIG. 2, the example 200 demonstrates the sharing of videos between users ‘A’ and ‘B’. In this example, the user ‘A’ has just posted a sixth video (6) to their profile 220 as a job video. The application server 110 may identify this update and attempt to link this video based on its tags, such as those listed relating to landscaping, with tags of master accounts who have registered their videos as having similar tags. Since user ‘B’ is a master landscaper with a service video, then that service video can be queued to be shown on user ‘A’s video feed in due course, especially when the master profile of user ‘B’ 124 is setup for a distance radius that includes a location of the user ‘A’ account. Similarly, the video #6 that user ‘A’ just posted seeking a landscaper will be sent to the queue for user ‘B’s feed. Thereafter, both users can casually scroll through their feeds, such as with any social network application and view one another's videos in an attempt that one party will contact the other party to setup a meeting to discuss a contractual agreement or other business dealing.

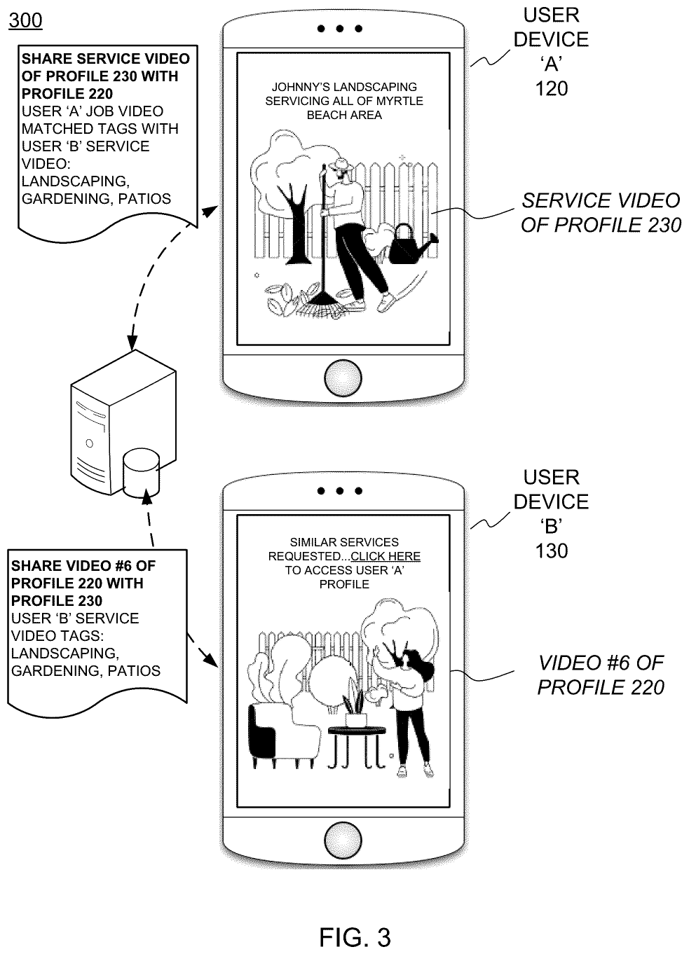

FIG. 3 illustrates another example graphical user interface (GUI) of an automated exchange of job and service postings, in accordance with example embodiments. Similar to the example in FIG. 2, this example illustration 300 demonstrates how a video from a master service provider “Johnny” and his landscaping company can be shared with a video feed on user ‘A’s device during a feed viewing operation. The tags from the job video and the service video are matched for a particular area (e.g., 60 miles, 30 miles, 10 miles, etc.). The radius settings may be established by either party; however, the master service provider will generally specify whether their skills are nationwide or local, and a radius distance that best suits the needs as a business. Also, the user profile ‘B’ may have a video that shows landscaping skills and which has the proper tags available for comparing and matching with tags from user ‘A’s profile. Once the match is made between profiles and the location parameters match, a video exchange will be queued for distribution to have one or more videos from user ‘A’s profile shared with user ‘B’s feed and one or more videos of user ‘B’s profile shared with the user ‘A’s feed.

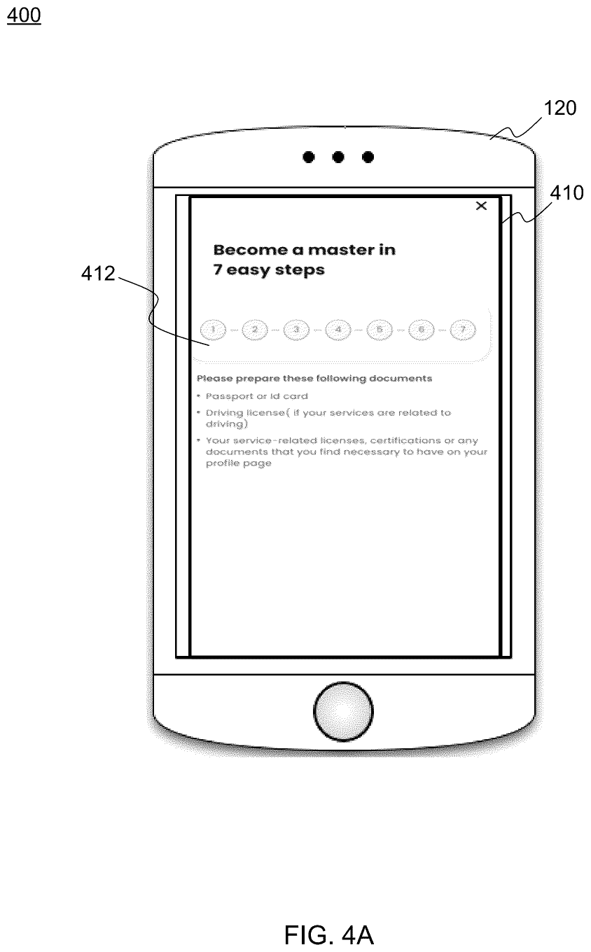

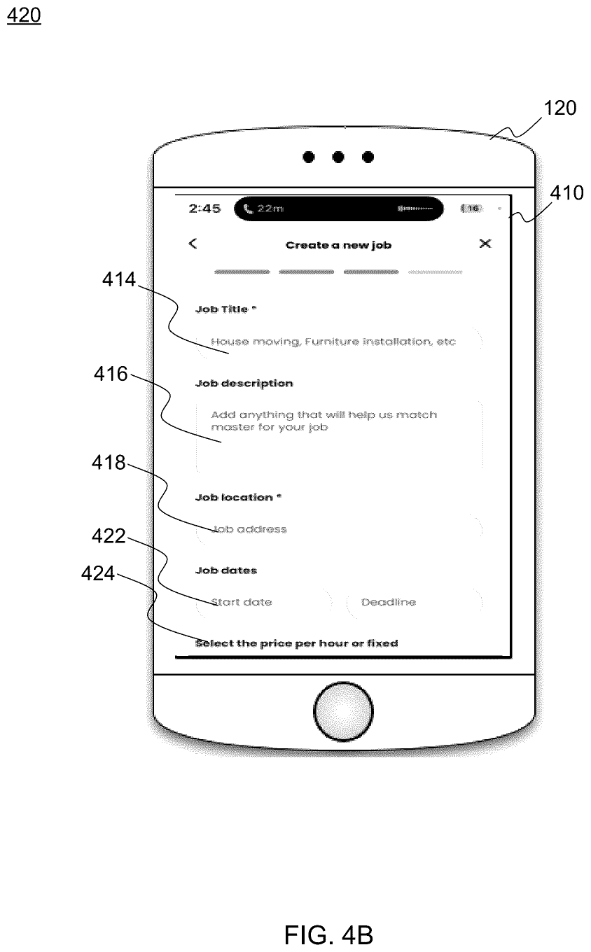

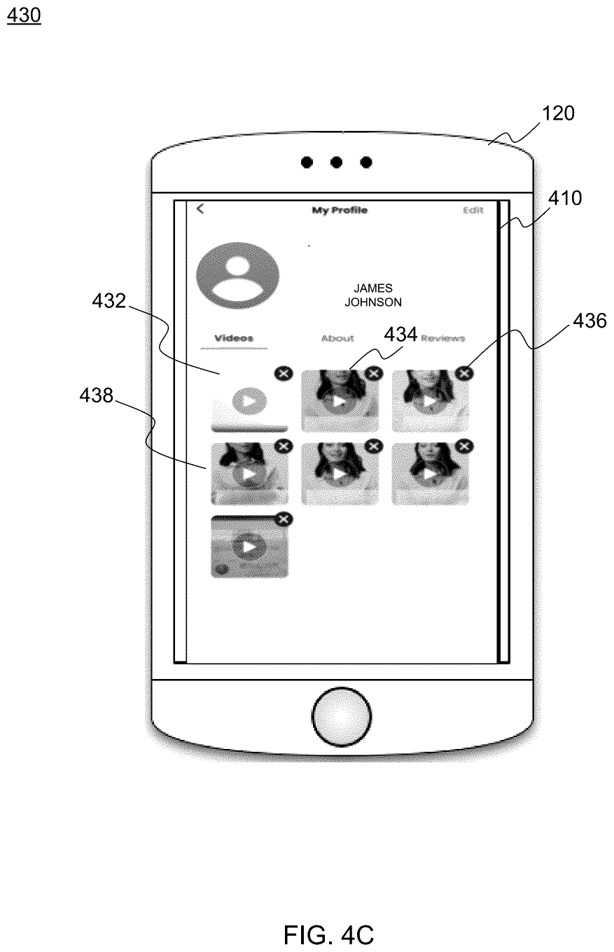

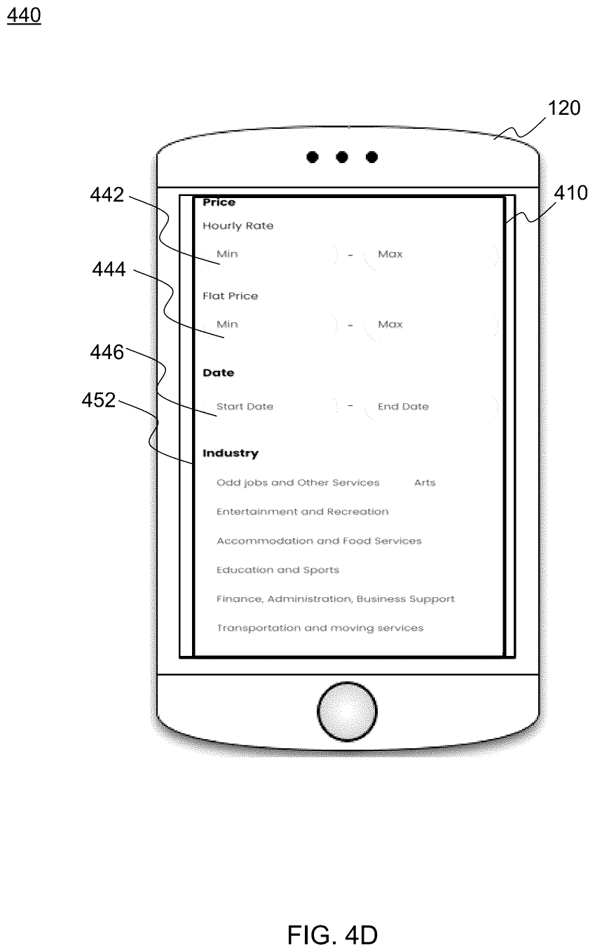

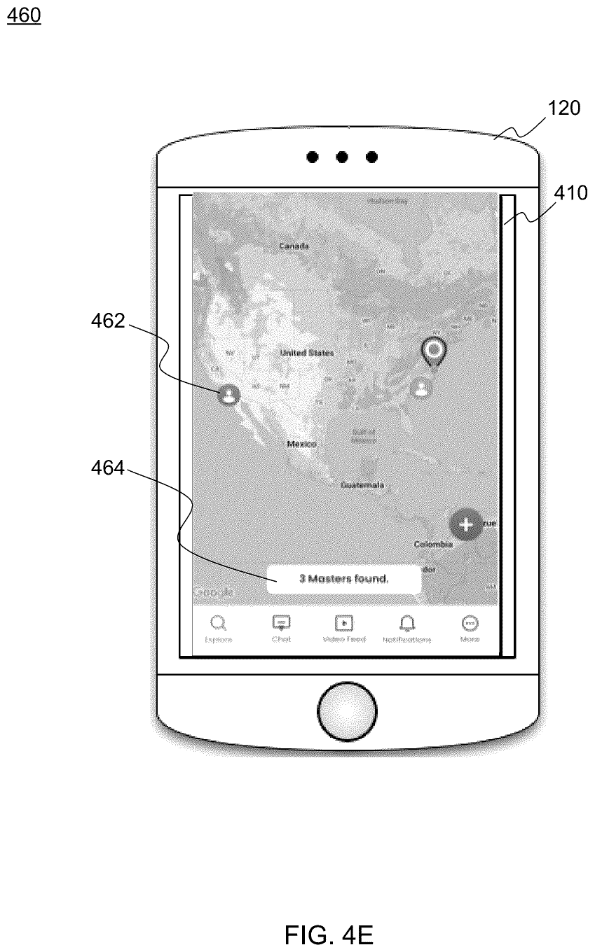

FIG. 4A illustrates another example graphical user interface (GUI) of a user device operating the job social networking application, in accordance with example embodiments. Referring to FIG. 4A, the example 400 includes a multi-step process for setting up a master account for posting professional videos which can be associated with job request videos of other users. The display interface 410 demonstrates the example menu 412 for establishing a master account.

FIG. 4B illustrates another example graphical user interface (GUI) of a user device operating the job social networking application to setup a new job posting, in accordance with example embodiments. Referring to FIG. 4B, the user interface example 420 includes a menu option to create a new job including a title 414, description 416, location 418, start and stop dates 422 and a price as an estimate to pay 424.

FIG. 4C illustrates another example graphical user interface (GUI) of a user device using the job social networking application to view a history of videos in a user profile, in accordance with example embodiments. Referring to FIG. 4C, the example 430 includes a profile with all the videos created 432-438 and a menu for the videos, information about the user and reviews as information that can be reviewed by other potential business candidates looking to hire or be hired.

FIG. 4D illustrates another example graphical user interface (GUI) of a user device using the job social networking application to establish job parameters in a user profile, in accordance with example embodiments. Referring to FIG. 4D, the example 440 demonstrates a user interface for establishing hourly rates 442, flat prices 444, dates 446 and industry tags 452 which are helpful for matching with others to increase feed video distribution.

FIG. 4E illustrates another example graphical user interface (GUI) of a user device displaying a map of candidates for jobs and services in the job social networking application, in accordance with example embodiments. Referring to FIG. 4E, the example 460 includes a map where one or more masters 462 and/or jobs or persons 464 are located to help users navigate the community of masters and job locations.

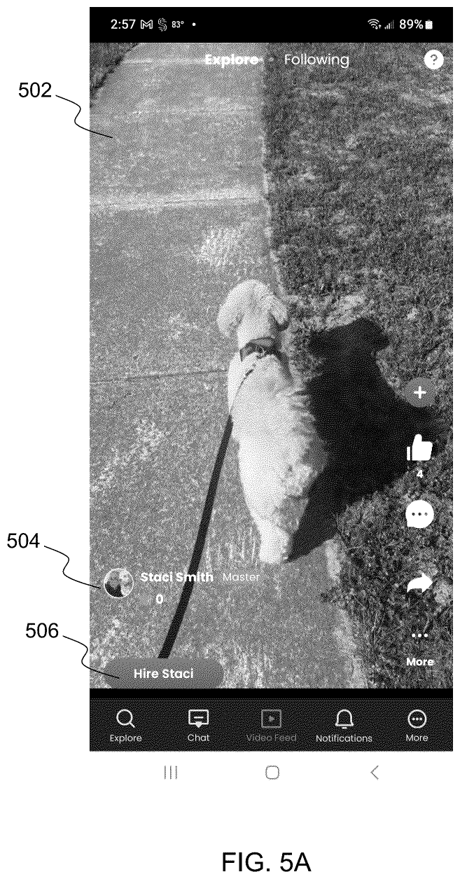

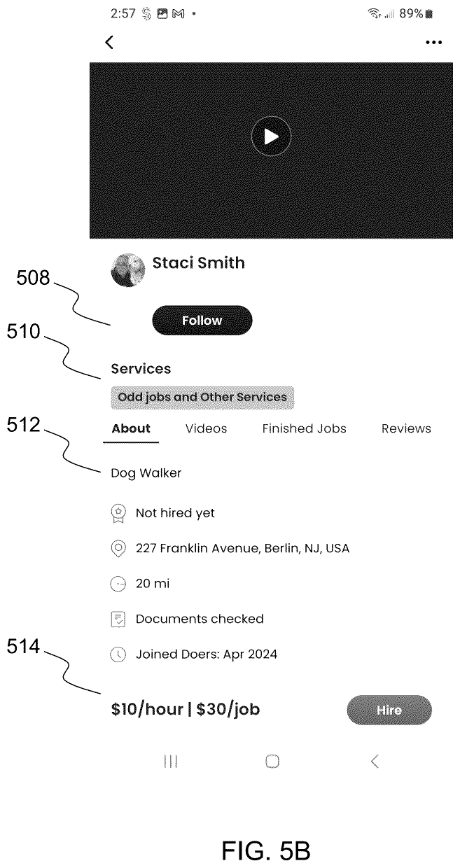

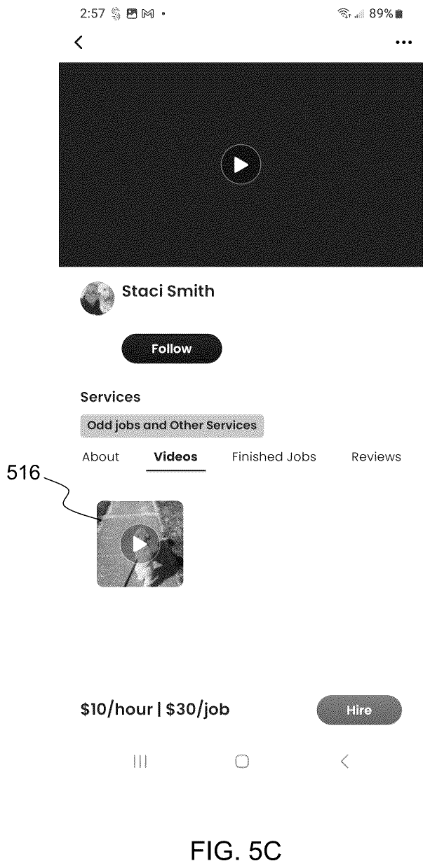

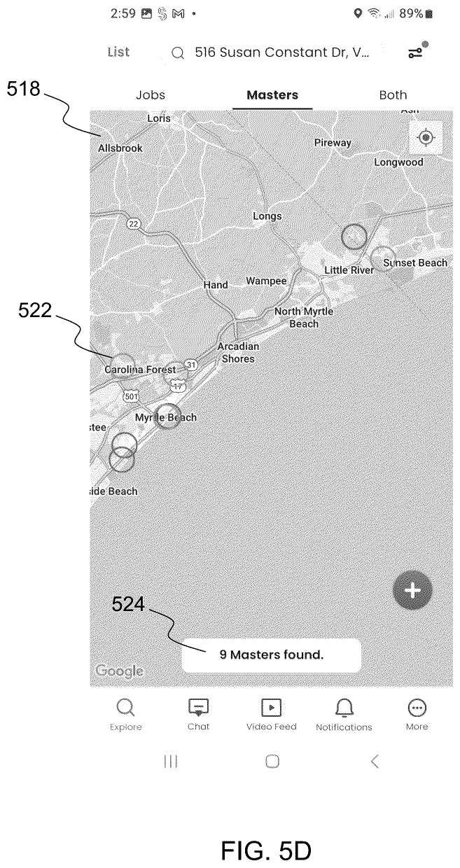

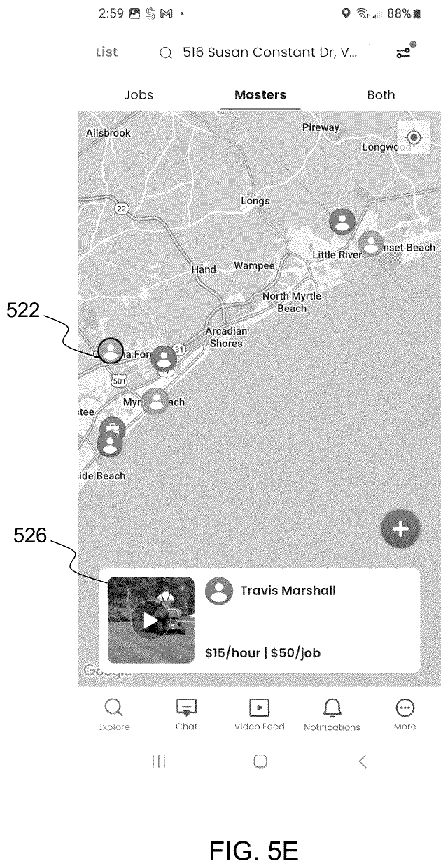

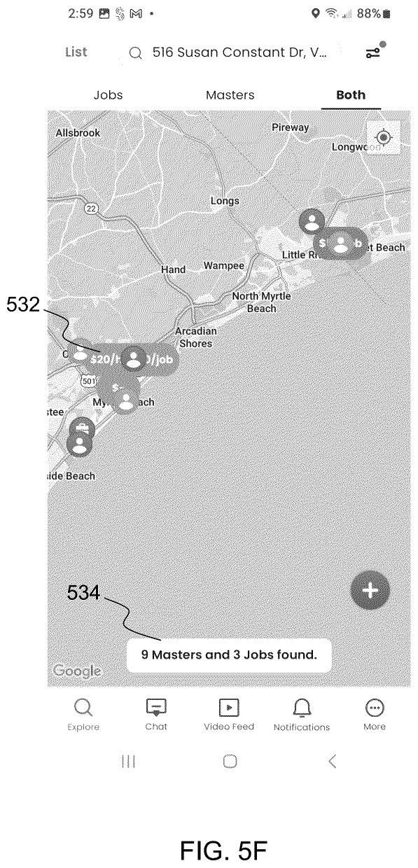

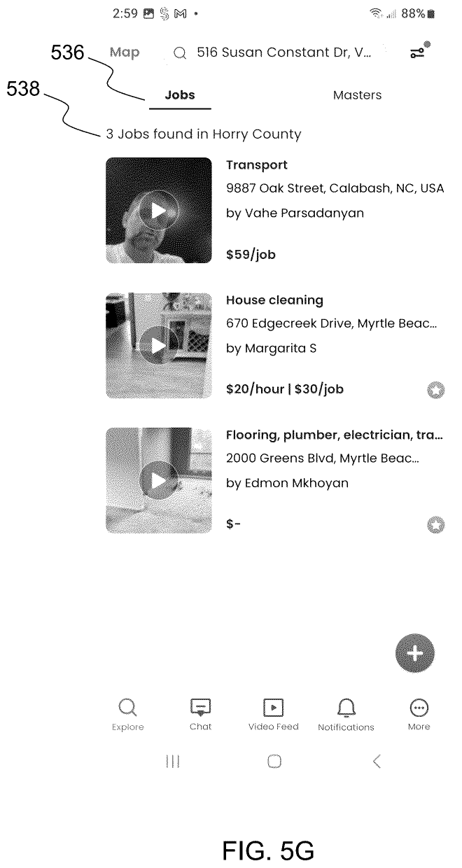

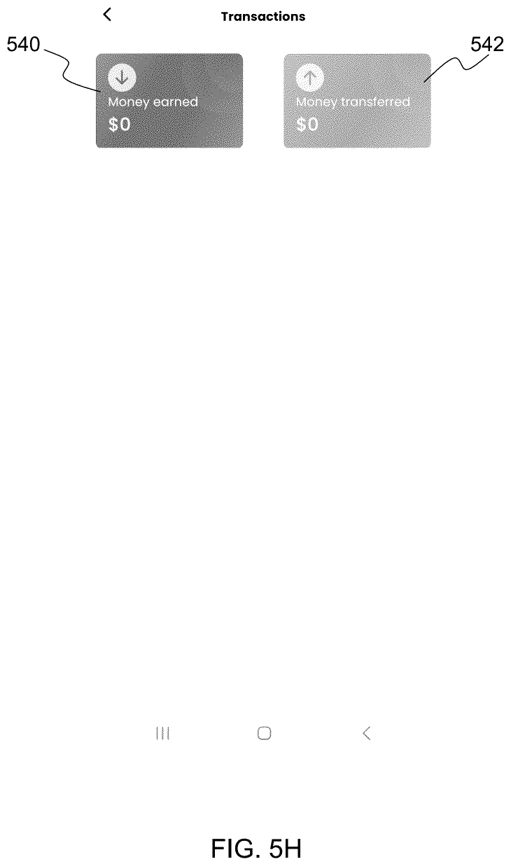

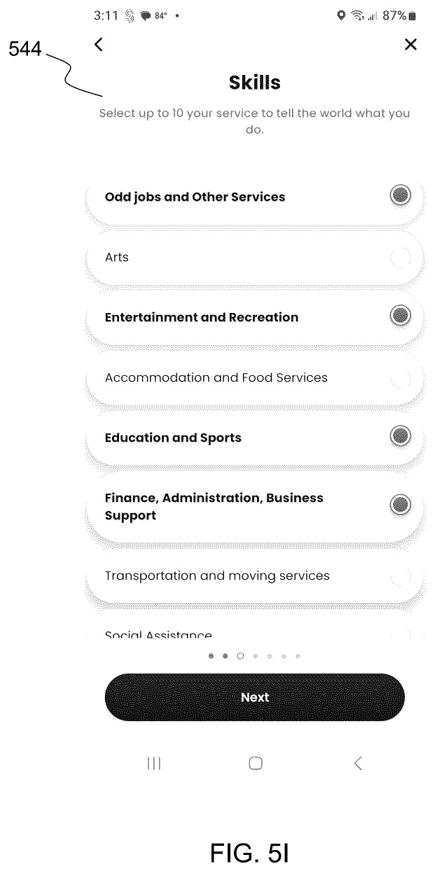

FIG. 5A illustrates an example video shared by a job master on their profile according to example embodiments. Referring to FIG. 5A, the example video 502 is illustrated in a user interface of a user account associated with the job sharing application. The video in this example is a dog walking video of a master user account seeking inquiries and jobs associated with dog walking services. The user name of the master account 504 is illustrated as well as a button 506 to initiate the linking process of establishing a hiring action to create a database entry to setup a job hiring action.

FIG. 5B illustrates an example profile page of a job master according to example embodiments. Referring to FIG. 5B, the user interface includes details of a particular user account, in this example this is a master user account 508 with established services 510, such as a dog walker 512, an address and other pertinent information for those seeking to hire the user of the master (service provider) account, along with other information, such as an hourly rate or job rate 514.

FIG. 5C illustrates another example of the profile page of a job master according to example embodiments. Referring to FIG. 5C, the user interface includes an example video 516 associated with the master job account profile. As more videos are made by the master user and shared on their respective account, those videos may be shared with others, such as job seeking user accounts that include one or more inquiries for services related to that particular master job account.

FIG. 5D illustrates an example map identifying locations associated with master profiles according to example embodiments. Referring to FIG. 5D, the map illustrates a geographical region of the east coast of the United States. In this region 518, a number of master accounts are identified by location identifiers 522 to demonstrate the location associated with their respective accounts. A total number of master accounts are also identified 524.

FIG. 5E illustrates an example map identifying locations associated with master profiles with a specific master selected according to example embodiments. Referring to FIG. 5E, the master profile selected will create a summary 526 with a name and one or more videos and/or other profile information for a user perusing the map the identify information about a particular master account.

FIG. 5F illustrates an example map identifying locations associated with master profiles and job profiles according to example embodiments. Referring to FIG. 5F, the map in this example includes job seeking profile locations as well as master accounts. An example job seeking profile may have hourly rate information 532 or other information that provides a shortcut to information of users of the application in a particular region, such as a summary 534 of master and job seeking accounts.

FIG. 5G illustrates an example user interface of a list of job videos associated with a particular location according to example embodiments. Referring to FIG. 5G, for a particular area 538, available jobs 536 may be organized along with a video, information pertaining to the user that posted the job that needs to be fulfilled. This menu option provides users, such as masters with a way to identify what jobs are available.

FIG. 5H illustrates an example user interface summarizing transactions performed by the job sharing application according to example embodiments. Referring to FIG. 5H, the user accounts may have a record of jobs accepted and/or assigned and an amount of earnings 540 and/or debits/transfers 542 for jobs accepted/assigned.

FIG. 5I illustrates an example list of skills which can be selected to associate with a particular user profile according to example embodiments. Referring to FIG. 5I, the setup options 544 of a user account for a master account may include an initial acceptance of various industries, skills, job labels, activities, etc., so user of other accounts can find and identify your account when perusing the application menus.

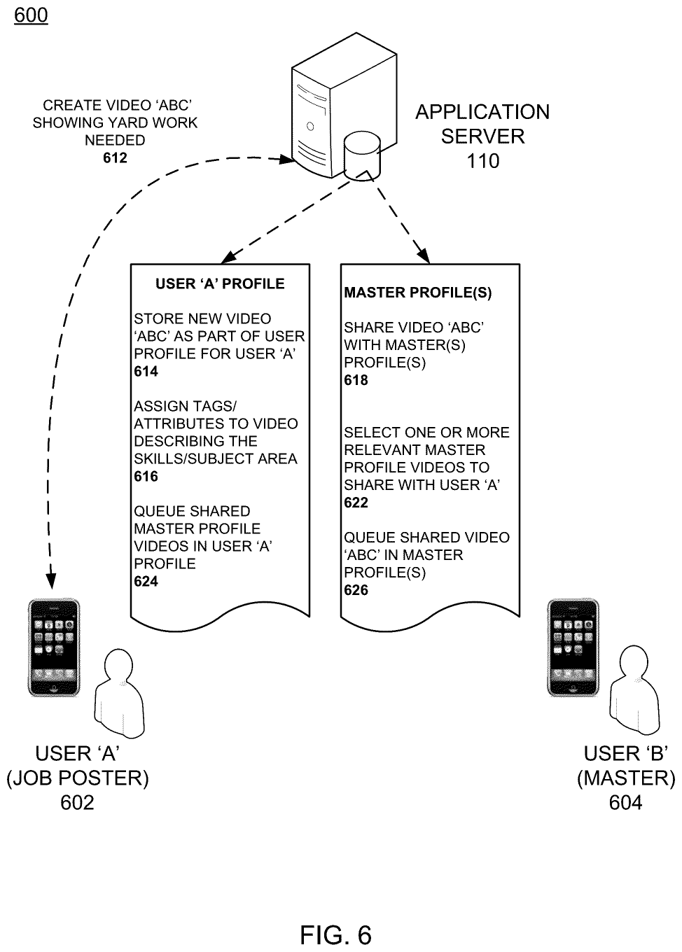

FIG. 6 illustrates an example user profile data queueing process according to example embodiments. Referring to FIG. 6, the example configuration 600 includes two user profiles one is a job posting account and the other a master profile. The process may include a user of a job profile posting a video demonstrating a job they need fulfilled 612. The application server may receive the job video and related content and store the video ‘ABC’ 614 as part of a user profile, assign the video tags automatically if the user has not selected those tags already 616, and share the video 618 by selecting one or more master accounts 622 and queueing the video 626 in the one or more qualifying master accounts for viewing. Similarly, the user profile may receive a video to be queued 624 from those qualifying accounts of the master(s) accounts in exchange for the video shared by the user account of the job poster. By making a video, the application caused a video exchange based on content relevancy and location specifications between the new video and one or more previously made videos.

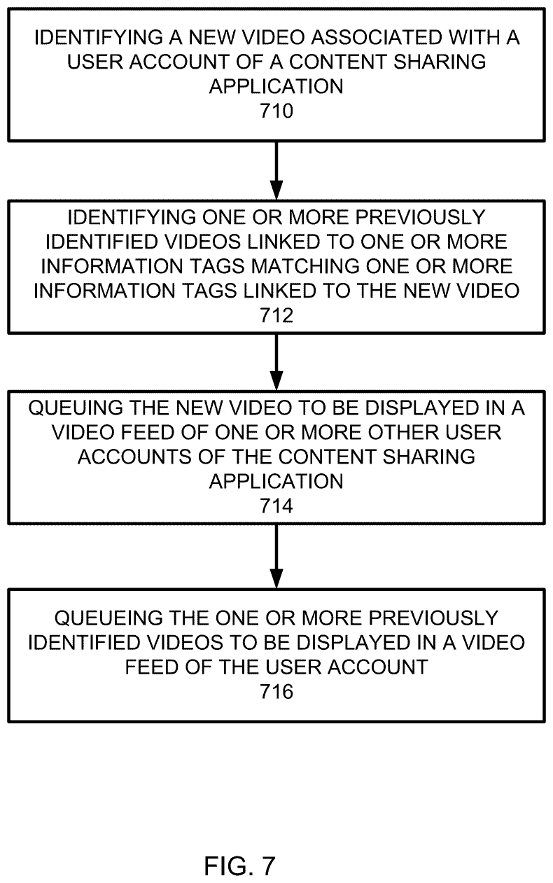

FIG. 7 illustrates an example process of sharing content among users of the job sharing application according to example embodiments. Referring to FIG. 7, the process may include identifying a new video associated with a user account of a content sharing application 710, identifying one or more previously identified videos linked to one or more information tags matching one or more information tags linked to the new video 712, queuing the new video to be displayed in a video feed of one or more other user accounts of the content sharing application 714, and queueing the one or more previously identified videos to be displayed in a video feed of the user account 716.

The process may also include linking a plurality of information tags to the new video, and comparing the plurality of information tags of the new video to the one or more information tags linked the one or more previously identified videos, and performing the queuing of the new video in a plurality of the other user accounts when one or more matches occurs based on the comparison.

The process may also include determining one or more distance radiuses associated with the one or more other user accounts, and performing the queuing of the new video in the other user accounts which have a distance radius that includes a location associated with the user account. The process may also include determining one or more distance radiuses associated with the one or more other user accounts, and performing the queueing of the previously identified videos to be displayed in the video feed of the user account when the other user accounts have a distance radius that includes a location associated with the user account. The new video may be a job video associated with a job account and the previously identified videos are master profile videos associated with master accounts. The new video may be a master profile video associated with a master account and the previously identified videos are job videos associated with job accounts.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

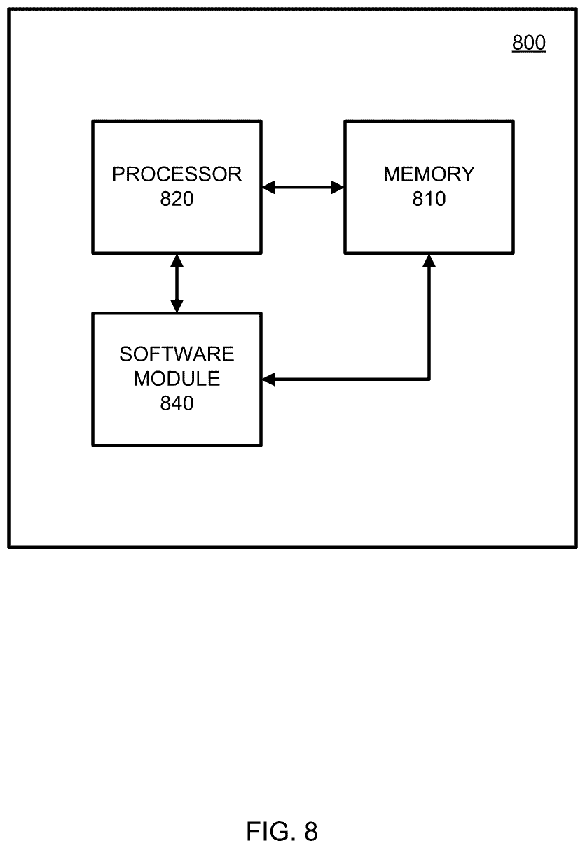

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 8 illustrates an example network element 800, which may represent any of the above-described network components, etc.

As illustrated in FIG. 8, a memory 810 and a processor 820 may be discrete components of the network entity 800 that are used to execute an application or set of operations. The application may be coded in software in a computer language understood by the processor 820, and stored in a computer readable medium, such as, the memory 810. The computer readable medium may be a non-transitory computer readable medium that includes tangible hardware components in addition to software stored in memory. Furthermore, a software module 830 may be another discrete entity that is part of the network entity 800, and which contains software instructions that may be executed by the processor 820. In addition to the above noted components of the network entity 800, the network entity 800 may also have a transmitter and receiver pair configured to receive and transmit communication signals (not shown).

Although an exemplary embodiment of the system, method, and computer readable medium of the present invention has been illustrated in the accompanied drawings and described in the foregoing detailed description, it will be understood that the invention is not limited to the embodiments disclosed, but is capable of numerous rearrangements, modifications, and substitutions without departing from the spirit or scope of the invention as set forth and defined by the following claims. For example, the capabilities of the system can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
identifying a new video associated with a user account of a content sharing application;
identifying one or more previously identified videos linked to one or more information tags matching one or more information tags linked to the new video;
queuing the new video to be displayed in a video feed of one or more other user accounts of the content sharing application; and
queueing the one or more previously identified videos to be displayed in a video feed of the user account.

2. The method of claim 1, comprising:
linking a plurality of information tags to the new video; and
comparing the plurality of information tags of the new video to the one or more information tags linked the one or more previously identified videos.

3. The method of claim 2, comprising
performing the queuing of the new video in a plurality of the other user accounts when one or more matches occurs based on the comparison.

4. The method of claim 1, comprising
determining one or more distance radiuses associated with the one or more other user accounts; and
performing the queuing of the new video in the other user accounts which have a distance radius that includes a location associated with the user account.

5. The method of claim 1, comprising
determining one or more distance radiuses associated with the one or more other user accounts; and
performing the queueing of the previously identified videos to be displayed in the video feed of the user account when the other user accounts have a distance radius that includes a location associated with the user account.

6. The method of claim 1, wherein the new video is a job video associated with a job account and the previously identified videos are master profile videos associated with master accounts.

7. The method of claim 1, wherein the new video is a master profile video associated with a master account and the previously identified videos are job videos associated with job accounts.

8. An apparatus comprising:
a processor configured to
identify a new video associated with a user account of a content sharing application;
identify one or more previously identified videos linked to one or more information tags matching one or more information tags linked to the new video;
queue the new video to be displayed in a video feed of one or more other user accounts of the content sharing application; and
queue the one or more previously identified videos to be displayed in a video feed of the user account.

9. The apparatus of claim 8, wherein the processor is further configured to
link a plurality of information tags to the new video; and
compare the plurality of information tags of the new video to the one or more information tags linked the one or more previously identified videos.

10. The apparatus of claim 9, wherein the processor is further configured to
perform the queuing of the new video in a plurality of the other user accounts when one or more matches occurs based on the comparison.

11. The apparatus of claim 8, wherein the processor is further configured to
determine one or more distance radiuses associated with the one or more other user accounts; and
perform the queuing of the new video in the other user accounts which have a distance radius that includes a location associated with the user account.

12. The apparatus of claim 8, wherein the processor is further configured to
determine one or more distance radiuses associated with the one or more other user accounts; and
perform the queueing of the previously identified videos to be displayed in the video feed of the user account when the other user accounts have a distance radius that includes a location associated with the user account.

13. The apparatus of claim 8, wherein the new video is a job video associated with a job account and the previously identified videos are master profile videos associated with master accounts.

14. The apparatus of claim 8, wherein the new video is a master profile video associated with a master account and the previously identified videos are job videos associated with job accounts.

15. A non-transitory computer readable storage medium configured to store instructions that when executed cause a processor to perform:
identifying a new video associated with a user account of a content sharing application;
identifying one or more previously identified videos linked to one or more information tags matching one or more information tags linked to the new video;
queuing the new video to be displayed in a video feed of one or more other user accounts of the content sharing application; and
queueing the one or more previously identified videos to be displayed in a video feed of the user account.

16. The non-transitory computer readable storage medium of claim 15, wherein the processor is further configured to perform:
linking a plurality of information tags to the new video; and
comparing the plurality of information tags of the new video to the one or more information tags linked the one or more previously identified videos.

17. The non-transitory computer readable storage medium of claim 16, wherein the processor is further configured to perform:
performing the queuing of the new video in a plurality of the other user accounts when one or more matches occurs based on the comparison.

18. The non-transitory computer readable storage medium of claim 15, wherein the processor is further configured to perform:
determining one or more distance radiuses associated with the one or more other user accounts; and
performing the queuing of the new video in the other user accounts which have a distance radius that includes a location associated with the user account.

19. The non-transitory computer readable storage medium of claim 15, wherein the processor is further configured to perform:
determining one or more distance radiuses associated with the one or more other user accounts; and
performing the queueing of the previously identified videos to be displayed in the video feed of the user account when the other user accounts have a distance radius that includes a location associated with the user account.

20. The non-transitory computer readable storage medium of claim 15, wherein the new video is a job video associated with a job account and the previously identified videos are master profile videos associated with master accounts.
